(19) United States
(12) Patent Application Publication
(10) Pub. No.: US 2004/0112500 A1
(43) Pub. Date: Jun. 17, 2004

(54) Method for thermally printing a dye image onto a three dimensional object using a dye carrier sheet

(75) Inventors: Patrick Ferguson, North Shields (GB); Kenneth Neri, Cranston, RI (US)

Correspondence Address: BARLOW, JOSEPHS & HOLMES, LTD., 101 DYER STREET, 5TH FLOOR, PROVIDENCE, RI, 02903, US

(73) Assignee: Key-Tech, Inc.

(21) Appl. No.: 10/728,048

(22) Filed: Dec. 4, 2003

Related U.S. Application Data
(60) Provisional application No. 60/430,865, filed on Dec. 4, 2002.

(51) Int. Cl. B44C 1/00

(52) U.S. Cl. 156/58

(57) ABSTRACT

The present invention relates to a method for thermally printing a pre-selected dye image onto a three dimensional object using an improved dye carrier sheet comprising a film substrate coated with a dye-receptive layer. The dye carrier sheet has high shrink-force, tensile strength, melt strength, and infrared (IR) absorption properties, and can conform tightly to the object. The film substrate is made from an ionomer copolymer of: i) α-olefins of the formula R—CH═CH₂, wherein R is a hydrogen atom or an alkyl radical having 1 to 8 carbon atoms, ii) α,β-ethylenically unsaturated carboxylic acids having 3 to 8 carbon atoms, and iii) optionally an additional monoethylenically unsaturated comonomer compound, wherein 10% to 90% of the carboxylic acid functional groups are ionized by neutralization via metallic ions distributed over the copolymer.

### CROSS-REFERENCE TO RELATED APPLICATIONS

This application claims the benefit of U.S. Provisional Application No. 60/430,865 having a filing date of Dec. 4, 2002, the entire contents of which are hereby incorporated by reference.

### BACKGROUND OF THE INVENTION

The present invention relates to a method for thermally printing a pre-selected dye image onto a three dimensional object using an improved dye carrier sheet. Particularly, the dye carrier sheet is coated with a dye-receptive layer and can thermoform tightly to the object.

The flexible dye carrier sheet of this invention is an improved carrier sheet that may be used with the thermal transfer printing system described in published U.S. Patent Application US 2002/0131062 (Neri and Mutter), the disclosure of which is hereby incorporated by reference.

In general, this printing system uses a vacuum and heating assembly. The system involves placing a carrier sheet containing a pre-selected, dye image over a three-dimensional object. An example of a suitable three-dimensional object is a plastic cover for a cellular telephone or a computer mouse. A flexible membrane is placed over the image carrier sheet. As the vacuum assembly draws the membrane into pressurized contact with the carrier sheet, the carrier sheet is wrapped around the various surfaces of the object to fully wrap the object. The carrier sheet and object are maintained in pressurized engagement with each other by the vacuum. The printed dye image on the carrier sheet is transferred to the object by heat. Particularly, an array of heating elements can be used to emit radiation onto the membrane and carrier sheet so that the dye image is transferred from the carrier sheet to the object.

Although some conventional dye carrier sheets can have generally good thermoforming properties and tensile strength so that the sheets can conform tightly to the shape of the cellular telephone, computer mouse, or other object, there is still a need for an improved dye carrier sheet that can be used in such printing operations. The present invention provides such a dye carrier sheet. These and other objects, features, and advantages of this invention are evident from the following description and illustrated embodiments.

### SUMMARY OF THE INVENTION

This invention relates generally to an improved method for thermally printing a pre-selected dye image onto a three dimensional object.

The method involves simultaneously applying a pre-selected dye image to multiple surfaces of a three dimensional object, comprising the steps of: a) providing a three dimensional object having an outer plastic surface for receiving an image, wherein the object has a top surface and a plurality of side surfaces which are adjacent to and not co-planar with the top surface; b) placing a flexible dye image carrier sheet in registration over the object, wherein the image carrier sheet has a pre-selected dye image printed thereon; c) lowering a flexible membrane over the three dimensional object and the image carrier sheet; d) establishing a vacuum under the membrane to cause the image carrier sheet to conform into pressurized communication with the top surface and side surfaces of the object; and e) heating the membrane and image carrier sheet to cause the image to transfer from the carrier sheet onto the top surface and side surfaces of the object.

The improvement involves using a carrier sheet comprising a film substrate comprising an ionomer copolymer of: i) α-olefins of the formula R—CH═CH₂, wherein R is a hydrogen atom or an alkyl radical having 1 to 8 carbon atoms, ii) α,β-ethylenically unsaturated carboxylic acids having 3 to 8 carbon atoms, and iii) optionally an additional monoethylenically unsaturated comonomer compound, wherein 10% to 90% of the carboxylic acid functional groups are ionized by neutralization via metallic ions distributed over the copolymer.

The film substrate is coated with a dye-receptive layer for receiving the pre-selected dye image. The film substrate may further comprise an intermediate barrier layer which is interposed between the dye-receptive layer and substrate. The dye-receptive layer may comprise a polymeric film-forming binder and pigment to absorb the dye image.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description taken in connection with the accompanying drawings in which:

FIG. 1 is a side perspective view of one embodiment of the dye carrier sheet of the present invention; and

FIG. 2 is a cross-sectional view of the printing assembly used to thermally transfer a dye image from the dye carrier sheet to an object in accordance with the present invention.

### DETAILED DESCRIPTION OF THE PREFERRED EMBODIMENTS

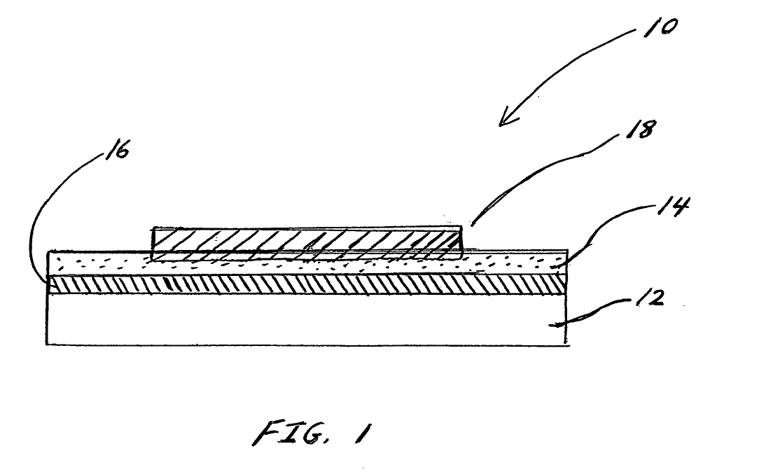

This invention relates generally to an improved dye carrier sheet that can be used to thermally transfer a pre-selected dye image from the sheet and onto a three dimensional object. Referring to FIG. 1, one embodiment of the dye carrier sheet is shown. The dye carrier sheet is generally indicated at 10 and comprises a film substrate 12 coated with a dye-receptive layer 14. An optional intermediate barrier layer 16 can be interposed between the film substrate 12 and dye-receptive layer 14 as described in further detail below. A pre-selected dye image 18 is printed onto the coated dye carrier sheet 10.

The film substrate 12 comprises an ionomer copolymer of: a) α-olefins of the formula R—CH═CH₂, wherein R is a hydrogen atom or an alkyl radical having 1 to 8 carbon atoms, b) α,β-ethylenically unsaturated carboxylic acids having 3 to 8 carbon atoms, and c) optionally an additional monoethylenically unsaturated comonomer compound, wherein 10% to 90% of the carboxylic acid functional groups are ionized by neutralization via metallic ions distributed over the copolymer. The ionomer copolymers and films made from these copolymers are known in the art and disclosed in Rees, U.S. Pat. No. 3,264,272 and Meilhon et al., U.S. Pat. No. 5,356,677, the disclosures of which are hereby incorporated by reference. The olefin may be ethylene and the carboxylic acid may be methacrylic acid or acrylic acid. The optional third monomeric unit includes, for example, vinyl acetate, methyl methacrylate and ethyl acrylate. Examples of ionomer copolymers containing a third monomeric unit include ethylene/vinyl acetate/methacrylic acid and ethylene/methyl methacrylate/methacrylic acid. Suitable metal ions that can be used as neutralizing ions include metals of Groups I, II, III, IV-A and VIII of the Periodic Table including Na, K, Li, Cs, Ag, Hg, Cu, Be, MG, Ca, Sr, and Ba.

These film substrates 12 are commercially available from E.I. du Pont de Nemours and Company under the trademark, SURLYN. For example, SURLYN 1601 can be used as a film substrate 12 in the present invention. The film substrate 12 can be used by itself or as a composite with other materials. For instance, the SURLYN film substrate 12 can be co-extruded with nylon.

The film substrate 12 of this invention has several advantageous properties including good thermoforming, high shrink-force, tensile strength, melt strength, and infrared (IR) absorption properties. The good thermoforming properties of the film allows the film to conform tightly to the shape of the object as it is drawn over the various surfaces and edges of the object. The film has high toughness and strength so it will not develop holes and tears as it is vacuum-drawn over the object. The high IR absorption properties of the film are important, since the film is treated with IR heat from heat emitters during the printing process and the good IR absorption creates short heat-transfer process cycle times.

The film substrate 12 is coated with a dye-receptive layer 14. For example, a coating formulation comprising pigment and polymer film-forming binder may be prepared and applied as the dye-receptive layer 14 to the film substrate 12. The pigment makes the coated layer 14 porous which permits good dye absorption and fixation of the dyes. For instance, the dye-receptive layer 14 may contain about 20 to about 80% by weight of pigment and about 80 to 20% by weight of polymer binder based on dry weight of the layer. In one embodiment, the dye-receptive layer contains about 50% by weight of pigment and about 50% by weight of polymer binder.

Optionally, at least one intermediate barrier layer 16 can be interposed between the film substrate 12 and coated dye-receptive layer 14. The barrier layer 16 helps prevent the migration of dyes into the film substrate 12. The barrier layer 16 can be a coated layer comprising various chemical components such as cross-linked polyvinyl alcohol. In other embodiments, the barrier layer 16 can be a metallized layer. For example, an aluminum metallized layer may be applied to the film substrate 12. If a metallized layer is used, it should be coated with an adhesion promoter such as a polyurethane/poly(vinyl acetate) blend so that it can bond effectively to the dye-receptive layer 14.

The pigment used to prepare the dye-receptive coating formulation can have a mean particle size in the range of 0.5 to 40 microns. The particle size distribution of the pigment can be broad or narrow. The pigment may have any shape, such as a spherical, hexagonal, rod, or plate-like shape, but it is usually spherically shaped. The pigment preferably has as a high surface area so that it can more effectively absorb the dyes. Examples of suitable pigments include silica, calcium sulfate, calcium carbonate, alumina, aluminum hydroxide, magnesium hydroxide, magnesium carbonate, barium sulfate, titanium dioxide, zinc oxide, tin oxide, zinc sulfate, zinc carbonate, kaolin, talc, clay, and the like. In one embodiment, silica pigment having a particle size distribution in the range of about 1 to about 20 microns can be used in the dye-receptive layer.

A film-forming binder can be added to the formulation to improve the film-forming properties of the coating and provide the dye-receptive layer with more cohesiveness and mechanical integrity. The binder can be a generally water-soluble material such as, for example, poly(vinyl alcohol), poly(vinyl pyrrolidone), gelatins, poly(vinyl acetate), poly(acrylic acids), polyethylene oxide, polyacrylates or polymethacrylates, cellulose derivatives such as cellulose ethers, carboxymethyl cellulose, and hydroxyethyl cellulose, proteins, casein, and starch. Mixtures and copolymers of the foregoing also can be used. In one embodiment, the dye-receptive layer can contain a mixture of poly(vinyl alcohol) and poly(vinyl acetate).

The coating formulation may further contain cross-linking agents that react during the drying step to increase the strength of the dye-receptive layer. Suitable cross-linking agents may include, for example, urea/formaldehyde or melamine/formaldehyde resins, aziridines, boric acid, and epoxy resins. Also, the coating formulation may contain cationic agents which help fix the anionic dyes. These cationic polymers may include, for example, cationic acrylates, acrylamides, amide/epichlorohydrin polymers, polyethyleneimines, polydiallylamines, and the like.

In addition, the coating formulation may contain additives such as optical brighteners, surface active agents that control the wetting or spreading action of the coating solution, thickeners, dispersant aids, adhesion promoters, pH adjusters, and the like.

The dye-receptive coating of the present invention can be applied to the film substrate using any suitable coating method including, roller, wire bar, dip, knife, extrusion, or gravure coating methods. The coating can be dried using conventional techniques such as hot forced air in an oven. The dye-receptive coating of this invention has several advantageous properties including good dye absorption and thermal stability.

Thermally transferable dyes are applied to the dye-receptive layer to form a pre-selected dye image on the coating. Any suitable printing technique may be used to print the image on the coating. A single dye or a mixture of dyes may be incorporated into the printing ink formulations to produce, for example, yellow, magenta, cyan and black inks. The dye image produced on the coating may be any distinctive mark such as, for example, alphabetic letters, numbers, symbols, patterns, geometric shapes, photographs and any other design. The dye image can be printed on the dye-receptive layer so that it is a mirror (backward facing) image. Then, the dye image may be thermally-transferred to the object using the below-described vacuum/heating process, and the image will appear as a true (frontward facing) image on the object.

If a sublimation dye is used, the dye image is sublimated and transferred to the desired surfaces of the object by a thermal-transfer process. In a heat fusible-type process, a heat-fusible dye is used. The heat softens the dye image and the softened dye is transferred to the desired surfaces of the object. The dye has a melting or softening point which is below the melting point of the object receiving the image. Other dyes known in the art may also be used in accordance with this invention.

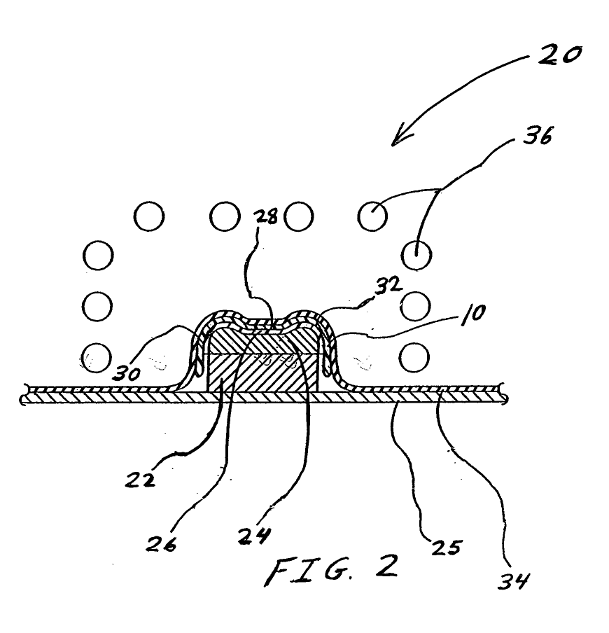

As discussed above, the thermal transfer printing system as described in published U.S. Patent Application US 2002/0131062 (Neri and Mutter) can be used to apply a pre-selected dye image 18 from the dye carrier sheet 10 to an object such as a plastic cellular telephone case. Referring to FIG. 2, this printing assembly is generally indicated at 20. The assembly 20 includes a support fixture 22 having a molded base 24 thereon that is designed to support the specific object to receive the pre-selected dye image 18. The support fixture 22 and molded base 24 are supported by support plate 25. The molded base 24 can be made from a silicone rubber material. In the embodiment shown in FIG. 2, the object is a plastic cellular telephone case 26. However, it is recognized that the assembly 20 can be used to apply the dye image 18 to other three dimensional objects such as a computer mouse. As shown in FIG. 2, the assembly 20 can be used to apply the dye image 18 to a cellular telephone case 26 having a top surface 28 and side surfaces 30 and 32. The dye carrier sheet 10 with the dye image 18 is placed over the telephone case 26. A flexible membrane 34 is placed over the dye carrier sheet 10. The flexible membrane 34 may be made from any suitable material such as a silicone rubber material. As a vacuum (not shown) draws the membrane 34 into pressurized contact with the dye carrier sheet 10, the carrier sheet 10 is wrapped around the top surface 28 and side surfaces 30 and 32 of the telephone case 26. The carrier sheet 10 tightly conforms to the irregular surfaces of the telephone case 26 and this action can be referred to as a “full-wrapping” action. The carrier sheet 10 and telephone case 26 are maintained in pressurized engagement with each other by the vacuum.

Then, the printed dye image 18 on the carrier sheet 10 is transferred to the telephone case 26 by heat. Particularly, an array of heating elements 36 can be used to emit heat radiation onto the membrane 34 and carrier sheet 10 so that the dye image 18 is thermally transferred from the carrier sheet 10 to the telephone case 26. Preferably, the heat radiation has a wavelength in the infrared region. Reflectors (not shown) may be used to direct the radiation towards certain areas of the membrane 34 and carrier sheet 10. Also, in other embodiments, the carrier sheet 10 is preheated either before or after the step of lowering the flexible membrane 34 over the carrier sheet 10 and prior to the step of establishing a vacuum. This preheating step improves the flexibility of the carrier sheet 10.

It is appreciated by those skilled in the art that various changes and modifications can be made to the illustrated embodiments herein without departing from the spirit of the invention. All such modifications and changes are intended to be covered by the appended claims.

What is claimed is:

1. A method of simultaneously applying a pre-selected dye image to multiple surfaces of a three dimensional object, comprising the steps of:
a) providing a three dimensional object having an outer plastic surface for receiving a dye image, said three dimensional object having a top surface and a plurality of side surfaces adjacent to and not co-planar with said top surface;
b) placing a flexible dye image carrier sheet in registration over said three dimensional object, said carrier sheet comprising a film substrate comprising an ionomer copolymer of: i) α-olefins of the formula R—CH═CH₂, wherein R is a hydrogen atom or an alkyl radical having 1 to 8 carbon atoms, ii) α,β-ethylenically unsaturated carboxylic acids having 3 to 8 carbon atoms, and iii) optionally an additional monoethylenically unsaturated comonomer compound, wherein 10% to 90% of the carboxylic acid functional groups are ionized by neutralization via metallic ions distributed over the copolymer, wherein said film substrate has a dye-receptive layer coated thereon, and said dye-receptive layer has a pre-selected dye image printed thereon;
c) lowering a flexible membrane over said three dimensional object and said image carrier sheet;
d) establishing a vacuum under said membrane to cause said image carrier sheet to conform into pressurized communication with said top surface and said side surfaces of said three dimensional object; and
e) heating said membrane and said dye image carrier sheet to cause said dye image to transfer from said image carrier sheet onto said top surface and said side surfaces of said three dimensional object.

2. The method of claim 1, wherein the film substrate further comprises an intermediate barrier layer, the barrier layer being interposed between the dye-receptive layer and film substrate.

3. The method of claim 1, wherein the dye-receptive layer comprises a polymeric film-forming binder and pigment.

4. The method of claim 1, wherein the flexible membrane comprises silicone rubber.

5. The method of claim 1, wherein a heating element emits heat radiation in the infrared range to heat the membrane and image carrier sheet.

6. The method of claim 5, further comprising the step of providing a plurality of heat reflectors to reflect the emitted heat radiation to the membrane and image carrier sheet.

7. The method of claim 1, further comprising the step of pre-heating the image carrier sheet either before or after the step of lowering the flexible membrane and prior to the step of establishing a vacuum.
